(19) United States
(12) Patent Application Publication
(10) Pub. No.: US 2020/0335086 A1
(43) Pub. Date: Oct. 22, 2020

(54) SPEECH DATA AUGMENTATION

(71) Applicant: Behavioral Signal Technologies, Inc., Los Angeles, CA (US)

(72) Inventors: Georgios Paraskevopoulos, Athens (GR); Evangelia Chatziagapi, Athens (GR); Theodoros Giannakopoulos, Athens (GR); Alexandros Potamianos, Santa Monica, CA (US); Shrikanth Narayanan, Santa Monica, CA (US)

(21) Appl. No.: 16/852,793

(22) Filed: Apr. 20, 2020

Related U.S. Application Data
(60) Provisional application No. 62/836,465, filed on Apr. 19, 2019.

(51) Int. Cl. G10L 15/06; G06N 20/00; G10L 15/16

(52) U.S. Cl. CPC G10L 15/063; G10L 15/16; G06N 20/00

(57) ABSTRACT

Data augmentation is used for speech emotion recognition tasks where certain emotional labels, e.g., sadness, are significantly underrepresented in a training dataset. This is typical for data collected in real-life applications. We propose conditioned data augmentation using Generative Adversarial Networks (GANs), in order to generate samples for underrepresented emotions. We propose a conditional GAN architecture to generate synthetic spectrograms for the minority class. For comparison purposes, we implement a series of signal-based data augmentation methods. Results on the speech emotion recognition task show that the proposed data augmentation method significantly improves classification performance as compared to traditional speech data augmentation methods.

### CROSS-REFERENCE TO RELATED APPLICATIONS

This application claims the benefit of U.S. Provisional Application No. 62/836,465, filed on Apr. 19, 2019, which is incorporated herein by reference.

### BACKGROUND

This application relates to data augmentation of audio, speech or multimodal information signals, and more particularly to such augmentation for speech emotion recognition.

Data augmentation is a method for generating synthetic data for classification, tracking or recognition machine learning tasks. Data augmentation may be effective for machine learning and deep learning tasks where there are few training examples available or some labels are underrepresented in training (sparse data). Traditional data augmentation techniques for audio, speech and multimodal processing applications have relied on perturbation of the speech signal in the time- and/or frequency-domain, e.g., time-scale modification, pitch modification, vocal-tract length modification, or with modifying the recording conditions under with the signal was recorded, e.g., varying types and amounts of noise. Such data augmentation methods have had limited success in classification, tracking and recognition tasks, perhaps because the perturbations are done in an arbitrary manner, without taking into account if the resulting signals are close to real signals or relevant to the machine learning problem at hand, i.e., residing close to the decision boundary.

In all types of human-human or human-computer interaction, the manner in which the words are spoken conveys important non-linguistic information, especially with regards to the underlying emotions. Therefore, it has become obvious that modern speech analysis systems should be able to analyze this emotion-related non-linguistic dimension, along with the message of the utterance itself. For that reason, during the last years, methods that automatically identify the emotional content of a spoken utterance draw a growing research attention. Speech Emotion Recognition (SER) is an audio task that maps audio of low-level audio features to either high-level class labels of distinct emotions or scalar values of affective dimensions, such as valence and arousal. In any case, annotated datasets are of great importance in building and evaluating SER systems.

As with many classification problems, feature representation plays an important role in SER. Audio features need to efficiently characterize the emotional content, without depending on the speaker attributes or the background noise. Widely adopted hand-crafted audio representations include spectral-domain (e.g. spectral centroid and flux), cepstral-domain, e.g. Mel-Frequency Cepstral Coefficients (MFCCs), and pitch-related features. Spectrograms have also been used along with Convolutional Neural Networks (CNNs) as image classifiers. CNNs are able to deal with high-dimensional inputs and learn features that are invariant to small variations and distortions. Furthermore, it has been shown that Recurrent Neural Networks (RNNs), such as Long Short-Term Memory units (LSTM), are able to take into account the temporal information in speech, resulting in a more robust modeling of the speech signals. LSTMs can also be combined with CNNs in order to automatically learn the best signal representation. Spectrograms can be extracted both from the speech and glottal flow signals, while spectrogram encoding may be performed by a stacked autoencoder and an RNN trained trained to predict primary emotions.

Data with non-uniform or highly skewed distributions among classes is a common issue in SER. During the processes of data collection and annotation, neutral speech samples are much more frequent than the emotionally-charged ones, leading to highly imbalanced datasets. A common way to address data imbalance is through data augmentation techniques. Data augmentation techniques can be performed at the feature-space through oversampling or can generate synthetic samples through transformations in the data-space.

Generative Adversarial Networks (GANs) are powerful generative models that try to approximate the data distribution by training simultaneously two competing networks, a generator and a discriminator [1]. The GAN ability to generate realistic in-distribution samples has been leveraged for data augmentation. For example, a GAN can be trained to generate in-class samples [2]. A CycleGAN architecture has been adapted for emotion classification from facial expressions [3, 4]. As for the speech domain, synthetic feature vectors have been used to improve the classifier's performance on an emotion task [5]. A conditional GAN architecture has been proposed to address data imbalance in image data [6].

### SUMMARY

Data augmentation is especially relevant for speech emotion recognition tasks where certain emotional labels, e.g., sadness, are significantly underrepresented in most datasets collected in real-life applications. Results on a speech emotion recognition task show that the present method significantly improves classification performance as compared to traditional speech data augmentation methods.

In one aspect, in general, audio, speech or multimodal information signals are augmented using a discriminative approach that uses synthetic samples selected from a generative adversarial network. The approach can produce synthetic audio and speech spectrograms that closely resemble spectrograms of real audio and speech signals, without under or over-smoothing the time- and frequency-domain information representation in the spectrogram. Furthermore, the proposed method outperforms traditional data augmentation proposed in the literature.

Some inventive aspects described in this application include:
1. Method and system for discriminative data augmentation for deep learning.
2. The discriminative aspect of this data augmentation is realized in an adversarial fashion where samples supporting the inference are in competition with samples aimed at disrupting inference.
3. This method can be used to detect changes in human state from a baseline.
4. This method can be used for temporal tracking of human state or emotional/behavioral category change.
5. This data augmentation can be performed in a unimodal fashion such as from different audio sensors or different representations of the same sensor.
6. This data augmentation can be supported cross-modally such as augmenting audio using a concurrent respiratory signal.
7. This data augmentation can be done multi-modally such as joint augmentation between audio and physiological signals.
8. This method can be applied in either the native signal domain or some transform domain such as time-frequency signals such as audio spectrograms or wavelet decompositions of physiological signals.

The ability to process speech input to identify characteristics of the speech input, and thereby characteristics of the speaker, such as emotional state has practical applications, for example, in control of human-computer interactions and in medical diagnostics.

### DESCRIPTION OF DRAWINGS

FIG. 1 is a system block diagram.

FIG. 2 is a diagram of a spectrogram generator.

FIG. 3 is a diagram of a spectrogram discriminator.

FIG. 4 is a comparison of spectrograms using (a) an image generation approach and (b) the present approach.

FIG. 5 is a comparison of real and generated spectrograms for different emotion classes.

### DETAILED DESCRIPTION

### 1 Overview

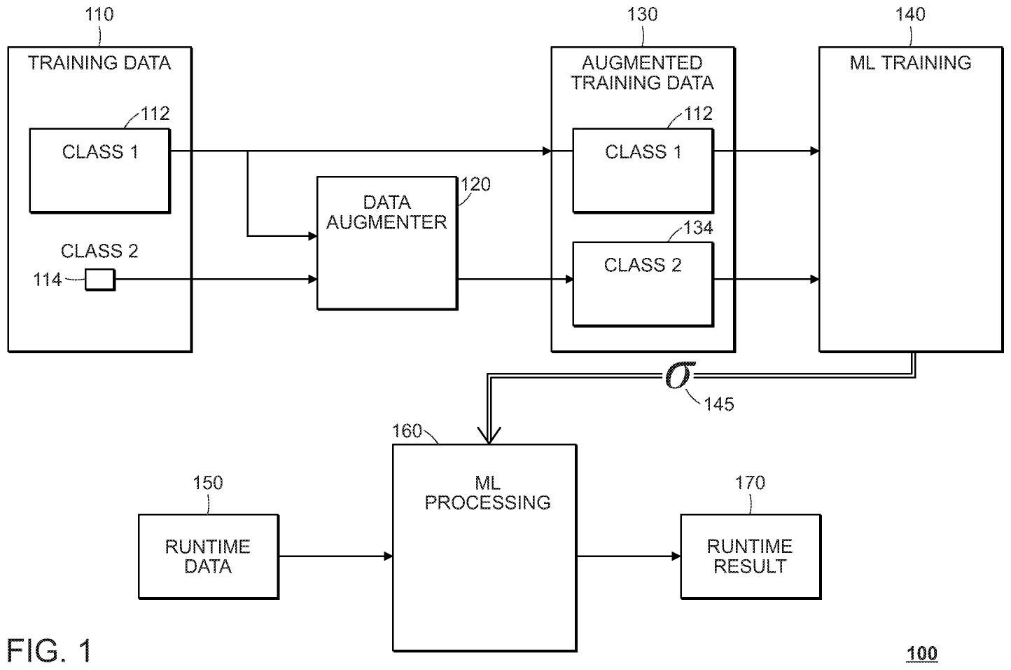

Referring to FIG. 1, a machine learning system 100 makes use of acoustic training data 110 (e.g., speech signal data), which includes two classes of data, class 1 data 112 and class 2 data 114. The class 2 data is underrepresented in the amount of the data as compared to class 1, for example with there being less than 50%, 10%, 1%, or 0.1% of the amount of data than is available for class 1. Ultimately, a parameterized machine-learning processing component 160 is configured with parameter values 145 so that it can process runtime data 150 and produce corresponding runtime results 170, for example, by classifying the runtime data as belonging to class 1 versus belonging to class 2.

To address the imbalance in the amount of training data that is available for class 2, before estimate the parameter values 145, the training data 110 is passed through a data augmenter 120, which synthesizes a training set of class 2 data 134, which includes the original data 114, and that is larger than was originally available. The synthesized class 2 data 134 is statistically similar to the small set of class 2 data 114 in the sense that it is difficult for an automated system to distinguish between original samples from data 114 as compared to synthesized samples produced by the data augmenter 120. Generally, a Generative Adversarial Network (GAN) approach is used to configure the data augmenter 120.

In an embodiment described below, the data samples are represented as spectrograms (intensity vs. time vs. frequency) of audio signals. The spectrograms for the training data 110 may be obtained by recording audio signals with microphones, and processing the recorded signals (waveforms) to produce the corresponding spectrograms. For the synthesized data, audio signals are not required and the data samples are directly produced by the data augmenter 120 in the spectrogram domain. Note that although described in the context of generation of spectrograms, the general approach may be adapted to produce synthesized audio signals for the under-represented class in a very similar manner.

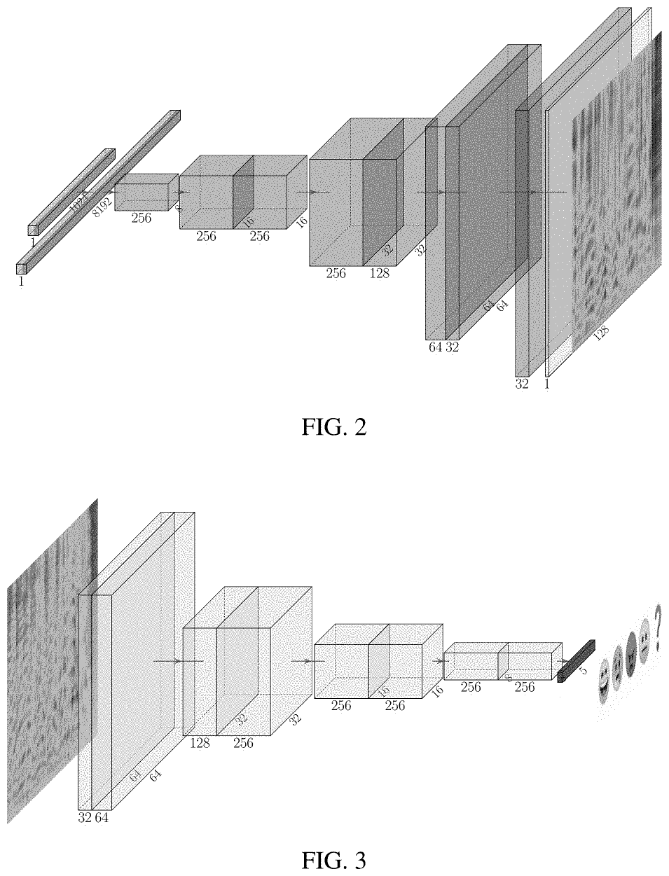

Although a spectrogram may be similar to an image/photograph of a physical space (i.e., intensity and/or color vs. x vs. y), certain aspects of the GAN approach are particularly adapted to generation of spectrogram. For example, an output layer of a spectrogram generator uses a transposed convolution layer, which improves the “realism” of synthesized spectrograms. In particular, the generator has a fully convolutional architecture as shown in FIG. 2. Similarly, a spectrogram discriminator, shown in FIG. 3 has multiple convolutional layers.

### 2 Preferred Embodiment

### 2.1 Method

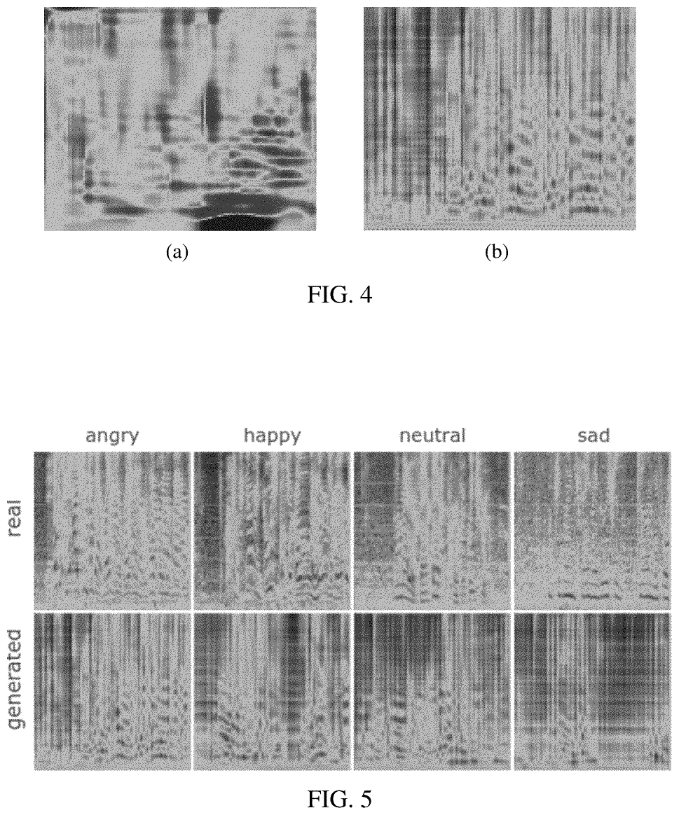

In this embodiment, a Balancing GAN (BAGAN) methodology is used used for data augmentation for Speech Emotion Recognition (SER). The basic concept behind this approach is the training of a GAN to generate realistic samples for the minority class. The generator contains a series of transposed convolutional and upsampling layers, while the discriminator consists of a series of convolutional layers. However, it is not sufficient to use a prior approach used for two-dimensional images to two-dimensional spectrograms. This can be seen by comparing a spectrogram “image” generated by a prior approach as shown in FIG. 4a with a spectrogram generated using the preferred approach detailed below as shown in FIG. 4b.

In the present approach, a fully convolutional architecture illustrated in FIGS. 2-3 is used. In FIG. 2, we show the generator G architecture, where we use 2 dense layers to project the input state to a higher dimensionality and 8 transposed convolutional layers to produce a spectrogram image. We double the stride in every second deconvolution layer to increase the height and width of the intermediate tensors. The final layer of G is a convolutional layer that converts the input tensor to a spectrogram image. In FIG. 3, the discriminator D uses 8 convolutional layers and a softmax classification layer to discriminate between fake spectrograms and spectrograms of a specific emotion class. Note that D does not perform a binary classification between real and fake samples, because the minority class samples would be misclassified as fake, due to their rarity.

In brief, the main steps of the present approach are: (a) Autoencoder training; (b) GAN initialization; and (c) GAN fine-tuning.

Autoencoder Training: For faster convergence, the GAN is initialized using a pre-trained autoencoder. The autoencoder consists of the encoder which corresponds to the D architecture, replacing the last softmax layer with a dense layer of size 100, and the decoder which has the same architecture as G. The autoencoder is trained using the whole imbalanced dataset, without any explicit class knowledge. In this step, the model learns weights close to a good solution, avoiding the issue of mode collapse during adversarial training.

GAN Initialization: The learned weights are transferred to the GAN modules—the encoder weights are transferred to D and the decoder to G respectively. For class conditioning, we calculate the mean and covariance matrix of the learned latent vectors of the autoencoder that correspond to the spectrogram of each class. In this way, we model each class with a multivariate normal distribution. Then, we sample at random a latent vector from the distribution of a specific class and provide it as input to G, which outputs a realistic spectrogram for this class. Contrary to the autoencoder, GAN has explicit class knowledge.

GAN Fine-tuning: The GAN is fine-tuned using both the minority and majority classes of the training data. In this way, it learns features that are shared between classes, e.g. dominant frequencies in the spectrogram. Such features contribute to a more qualitative image generation for the minority class. During fine-tuning, G takes as input the aforementioned latent vectors, that are extracted from the class-conditional latent vector generator. The latter takes as input uniformly distributed class labels. Then, the batches of real and generated spectrogram are forwarded to D. The goal of each one of the two competing networks, G and D, is to optimize its loss function, for which sparse categorical cross-entropy is used. D is optimized to match the real spectrogram with the correct class labels and the generated ones with the fake label. As for G, it is optimized to match the labels selected by D with the labels used to generate the spectrograms. Following the GAN fine-tuning, we use G to generate artificial spectrograms for each class separately to reach the majority class population.

### 2.2 Implementation

The spectrograms are normalized in the [−1-1, ] range applying min-max normalization, so we use tan h activation at the decoder output. In both modules, batch normalization, dropout with p=0.2 and leaky ReLU activations are added after each (de)convolutional layer. Real and fake samples are fed to D separately in successive batches, mainly due to the use of batch normalization. In addition, we use Adam optimizer with learning rate 5×10⁻⁵ when training the autoencoder and decrease it to 10⁻⁶ when fine-tuning the GAN.

### 2.3 Architecture Features

The GAN-based augmentation method of the present approach includes use of transposed convolutions rather than an alternative of use of upsampling layers, and use of leaky ReLU for all the intermediate activation layers. Furthermore, batch normalization and dropout is used, and the discriminator is fed with separate batches of real and fake images. The present fully convolutional architecture avoids extreme values in the generated spectrograms. An example of such artifacts, e.g., regions with zero and one values, as demonstrated in FIG. 4. Examples of real and synthesized spectrograms for common distinct emotion classes are demonstrated in FIG. 5, where such artifacts are avoided. Assuming a real-world imbalanced emotion dataset, the present approach generates high-quality spectrograms for underrepresented classes.

### 2.4 Baseline Methodologies

For comparison purposes, we implement a series of baseline methods to balance our initial dataset. A first approach is the random removal of samples from the majority classes so that all classes are of equal size. This random selection can be applied with a number of ratios, considering the less populated to the most dominant class. Since this technique results in less data for training, maybe removing useful information as well, we additionally investigate various data augmentation methods. After the augmentation process, all classes are represented by the same number of samples as the majority class.

We focus on signal-based transformations, that are followed in the literature. We apply time stretch (TS), that changes the audio signal duration without affecting its pitch, pitch shift (PS), that changes the pitch without affecting its duration and finally noise addition to the original speech utterance (either Gaussian noise, GN, or true background audio noise, BN). In the case of BN, background noise has been extracted from signals of the ESC-50 [7] and FMA [8] datasets. In addition, we try the simple technique of sample copying (CP), randomly adding identical copies of preexisting samples.

Combining all the aforementioned methods, we create a set of experimental augmentation strategies, described in Table 1: Signal-based Audio Augmentation (SA), SA with replacement (SAR), SA with replacement of the majority class only (SAR_{M}), SAR adding only Background Noise (SAR_{B}), SAR using only TS and PS (SAR_{S}). The replacement mentioned refers to the case of replacing audio samples with their noisy counterparts, instead of adding them. The number of samples chosen for replacement for each class is equal to the difference between the specific class population and the minority class. This method aims to balance the percentages of noise samples of every class, in an attempt to prevent any bias towards classes with unusually high or low noise distribution. It can be applied for either all the classes or only the majority.

TABLE 1

| Method | CP | TS | PS | GN | BN | Replace |
|---|---|---|---|---|---|---|
| CP | ✓ | — | — | — | — | — |
| SA | — | ✓ | ✓ | ✓ | ✓ | — |
| SAR | — | ✓ | ✓ | ✓ | ✓ | All |
| SAR_{M} | — | ✓ | ✓ | ✓ | ✓ | Majority |
| SAR_{B} | — | — | — | — | ✓ | All |
| SAR_{S} | — | ✓ | ✓ | — | — | All |

### 3 Experimental Evaluation

### 3.1 Datasets Description

IEMOCAP (interactive emotional dyadic motion capture database) is a widely adopted corpus for emotional data, collected by the Speech Analysis and Interpretation Laboratory (SAIL) at the University of Southern California (USC) [9]. It has been recorded from ten actors in dyadic sessions, including both emotional scripts and improvised hypothetical scenarios. The scenarios have been designed to elicit specific types of emotions, namely: happiness, anger, sadness, frustration and neutral state, while additional emotions (excitement, fear, disgust, surprise and other) are also included in the final annotations. It contains approximately 12 hours of speech and it is considered a standard in most of the SER publications during the last years. In this work, we use four emotion classes: angry, happy, sad and neutral, merging the happy and excited classes, which results in 5531 speech utterances of about 7 hours total duration.

Despite its wide adoption, the IEMOCAP dataset (a) contains limited number of speakers and (b) is quite balanced. On the contrary, in the real world, high imbalance can be noticed, as well as diversity of different domains. Therefore, part of our internal (not publicly available) dataset, FEEL-25k, is also used to evaluate the augmentation methods. In particular, FEEL-25k contains almost 25k utterances from several domains, including films, TV series and podcasts. Its total duration is approximately 49 hours and the ratio of the less populated (sad) to the most dominant (neutral) class is ⅕. The emotion classes are: angry, happy, neutral, sad and ambiguous. The latter contains speech samples for which the inter-annotator agreement was lower than a particular threshold. Each segment has been labeled by 3 to 7 human annotators. A separate and large dataset, which is constructed similarly to FEEL-25k and consists of data drawn from the same broad domains, is used for testing. It is composed of almost 50k utterances of 100 hours of total duration.

### 3.2 Experimental Setup

Feature Extraction and Classification: The data augmentation methods have been evaluated in terms of the classification performance of a CNN. In particular, we have chosen the VGG19 architecture [10], which results in state-of-the-art performance on IEMOCAP. The network takes as input mel-scaled spectrograms, that are extracted from fix-sized segments of 3 seconds, after breaking each spoken utterance. During the spectrogram extraction a short-term window of 50 milliseconds with a 50% overlap ratio has been adopted, while the number of Mel coefficients is 128. This results in fix-sized spectrograms of 128×128. Logarithmic scale has been applied after the frequency power calculation.

Train-Test Data Split: For the evaluation experiments on IEMOCAP, we use 5 fold cross-validation, namely leave-one-session-out, using 4 sessions for training and 1 for testing. This setup is a common practice for IEMOCAP in related SER publications. As far as FEEL-25k is concerned, cross-validation is not needed due to the dataset's size and diversity. Instead, we have used a shuffle split of 80%-20% for training and validation respectively. A separate dataset is used for testing, as explained in Sec. 3.1.

For both datasets, we perform spectrogram normalization (see Sec. 2.2), computing the parameters from the training set and applying them to the validation and test sets. We report the average performance on the test set, after calculating the majority voting of the segment-level labels for every utterance. When applying this classification scheme on the whole IEMOCAP dataset, we achieve an Unweighted Average Recall (UAR) of 56%, which shows a performance improvement of about 1.2% in comparison to the non pre-trained AlexNet and VGG16 [11].

Datasets Imbalance Strategy: Since IEMOCAP is almost balanced, we simulate the imbalance issue for each emotional class separately, i.e. happy, angry and sad, except neutral. For every class, we remove 80% of the specific class from the training set, selected at random, in order to reproduce the difficulty of the classification task when this class is underrepresented. The validation set remains unmodified. In the case of FEEL-25k, which is gathered “in the wild” and as a result is imbalanced, we apply directly the audio data augmentation methodologies. The resulting training set in both datasets is then augmented using the aforementioned approaches.

### 3.3 Performance Results

In this section, we present the performance results for both datasets. In Table 2 we demonstrate the performance achieved on IEMOCAP. We use UAR metric to be comparable with other works in the literature. Each column named after an emotional class corresponds to the simulation described in Sec. 3.2, where we remove the 80% of the class samples in the training set and then augment it using one of the methodologies. In the final column, we compute the average scores of those simulations to assess the overall performance. The rows correspond to the different augmentation methods, as described in Sec. 2. For IEMOCAP, we did not try any random undersampling, since the minority class in the imbalanced training set contains a tiny amount of samples (approximately 180), making CNN training almost impossible. We see that the proposed approach achieves almost 10% relative performance improvement.

TABLE 2

| Dataset | Angry | Happy | Sad | Average |
|---|---|---|---|---|
| Imbalanced | 47.8 | 52.2 | 46.9 | 49.0 |
| CP | 51.5 | 50.8 | 45.8 | 49.4 |
| SA | 49.7 | 49.6 | 47.6 | 49.0 |
| Proposed approach | 53.5 | 55.2 | 52.1 | 53.6 |

Extensive experimental results are presented in Table 3 for FEEL-25k for the various augmentation methods. We show both the UAR and F-score results, since F-score computation combines both recall and precision. It can be observed that all the attempts to balance the dataset give suboptimal results in comparison to the initial distribution, with the exception of data generation using the proposed approach, which achieves almost 5% relative improvement. In general, the signal-based transformations can lead to overfitting, due to the existence of similar samples in the training set, while random balance removes possibly useful information. On the contrary, the GAN-based augmentation method generates high-quality spectrograms. After the fine-tuning, it can be easily used to generate as many spectrograms as needed for the underrepresented emotion classes.

TABLE 3

| Category | Dataset | UAR | F-score |
|---|---|---|---|
| — | Initial Dataset | 52.3 | 52.7 |
| Random | 0.4 Balanced | 50.0 | 50.3 |
| Selection | 0.6 Balanced | 48.5 | 48.1 |
| | 0.8 Balanced | 49.6 | 49.5 |
| | Fully Balanced | 49.4 | 48.9 |
| Signal-based | CP | 51.1 | 49.8 |
| Augmentation | SA | 50.7 | 49.2 |
| | SAR | 51.2 | 50.0 |
| | SAR_{M} | 51.0 | 50.5 |
| | SAR_{B} | 51.1 | 49.7 |
| | SAR_{S} | 49.3 | 48.0 |
| Generation | Proposed approach | 54.6 | 55.0 |

### Alternatives and Implementations

The method can be used for a variety of machine learning, statistical modeling, pattern recognition and artificial intelligence tasks. Data augmentation is especially relevant when there is a limited amount of training data, e.g., speech recognition (speech-to-text) for under resourced languages where large training databases are not available, or when there are underrepresented labels in the training set, e.g., for speech emotion recognition, emotion change detection or behavior tracking. Emotion or behavioral change detection refers to the problem of identifying changes of the state of a speaker from the baseline emotional or behavioral state.

Discriminative data augmentation can improve performance on any task, however, even for tasks where there are large amounts of training data.

The proposed method can be expanded to cross-modal and multi-modal data augmentation. For example, one can generate in addition to speech/audio, also text, image, or biological signals using discriminative data augmentation. The information signals for other modalities can be produced independently (cross-modal case) or in direct correspondence to the speech/audio signal (multi-modal case). For example, one can generate jointly speech spectrogram and the associated transcript (text) corresponding to that speech signal using a coupled generative adversarial network.

Although in our preferred embodiment we present a method that generates time-frequency representations, discriminative data augmentation can also be applied using similar architectures also in the time-domain, e.g., using a WaveGAN for adversarial audio synthesis [12].

In some alternatives, LSTMs can be combined the CNN classifier discussed above to take into account temporal information. Additionally, more sophisticated conditioning techniques and incorporating approaches from GANs for raw audio synthesis (i.e., rather than spectrograms) can be used to directly generate audio samples.

Implementations of the approaches described above may be implemented in software, with processor instructions being stored on a non-transitory machine-readable medium and executed by one or more processing systems. The processing systems may include general purpose processors, array processors, graphical processing units (GPUs), and the like. Certain modules may be implemented in hardware, for example, using application-specific integrated circuits (ASICs). For instance, a runtime machine learning processor may may use of a hardware or partially hardware implementation, while the machine-learning training may use a software implementation using general purpose processors and/or GPUs.

### REFERENCES

[1] I. Goodfellow, J. Pouget-Abadie, M. Mirza, B. Xu, D. Warde-Farley, S. Ozair, A. Courville, and Y. Bengio, “Generative adversarial nets,” in Advances in neural information processing systems, 2014, pp. 2672-2680.
[2] A. Antoniou, A. J. Storkey, and H. A. Edwards, “Data augmentation generative adversarial networks,” CoRR, vol. abs/1711.04340, 2018.

[3] X. Zhu, Y. Liu, Z. Qin, and J. Li, “Data augmentation in emotion classification using generative adversarial networks,” arXiv preprint arXiv: 1711.00648, 2017.
[4] J.-Y. Zhu, T. Park, P. Isola, and A. A. Efros, “Unpaired image-to-image translation using cycle-consistent adversarial networks,” in Proceedings of the IEEE International Conference on Computer Vision, 2017, pp. 2223-2232.
[5] S. Sahu, R. Gupta, and C. Espy-Wilson, “On enhancing speech emotion recognition using generative adversarial networks,” Interspeech 2018, September 2018.
[6] G. Mariani, F. Scheidegger, R. Istrate, C. Bekas, and C. Malossi, “Bagan: Data augmentation with balancing gan,” arXiv preprint arXiv:1803.09655, 2018.

[7] K. J. Piczak, “ESC: Dataset for Environmental Sound Classification,” in Proceedings of the 23rd Annual ACM Conference on Multimedia. ACM Press, 2015, pp. 1015-1018.
[8] M. Defferrard, K. Benzi, P. Vandergheynst, and X. Bresson, “Fma: A dataset for music analysis,” in 18th International Society for Music Information Retrieval Conference, 2017.

[9] C. Busso, M. Bulut, C.-C. Lee, A. Kazemzadeh, E. Mower, S. Kim, J. N. Chang, S. Lee, and S. S. Narayanan, “Iemocap: Interactive emotional dyadic motion capture database,” Language resources and evaluation, vol. 42, no. 4.

[10] K. Simonyan and A. Zisserman, “Very deep convolutional networks for large-scale image recognition,” in International Conference on Learning Representations, 2015.

[11] Y. Zhang, J. Du, Z. Wang, J. Zhang, and Y. Tu, “Attention based fully convolutional network for speech emotion recognition,” 2018 Asia-Pacific Signal and Information Processing Association Annual Summit and Conference (APSIPA ASC), November 2018.

[12] C. Donahue, J. McAuley, and M. Puckette, “Adversarial audio synthesis,” in International Conference on Learning Representations, 2019.

What is claimed is:

1. A method for configuring a speech processor comprising:
receiving training data include data for a plurality of classes, including first class data and second class data, where the amount of the second class data is substantially less than the amount of the first class data;
processing the training data to produce augmented training data, the augmented data including synthesized second class data, wherein the processing of the training data includes configuring a generative adversarial network (GAN) according the the second class data, and using a generator of the GAN to produce the synthesized second class data; and
using the augmented training data by a machine-learning training system to determine values of configuration parameters for use by a machine-learning processor.

2. The method of claim 1 further comprising:
processing an input signals using the machine-learning processor configured with the determined values of the configuration parameters to produce a result, the result characterizing the input signals according to the their similarity to the second class data.

3. The method of claim 1 wherein the training data comprises spectrogram data representing audio signals acquired using microphones.

4. The method of claim 1 wherein the classes include emotion-based classes.

5. The method of claim 1 wherein the classes include constructs representing human internal states and/or traits based classes.

6. The method of claim 5 wherein the human internal states include at least one of an emotion and a health condition state.

7. The method of claim 5 wherein the trait based classes include at least one of an identify and a personality class.

8. The method of claim 5 wherein targets include detection in changes in the construct states.

9. The method of claim 5 wherein targets include integrated representation of states and traits.

10. A non-transitory machine-readable medium having instructions stored thereon, wherein the instructions when executed by a computer processor cause a speech processor to be configured, the configuring of the speech processor comprising:
receiving training data include data for a plurality of classes, including first class data and second class data, where the amount of the second class data is substantially less than the amount of the first class data;
processing the training data to produce augmented training data, the augmented data including synthesized second class data, wherein the processing of the training data includes configuring a generative adversarial network (GAN) according the the second class data, and using a generator of the GAN to produce the synthesized second class data; and
using the augmented training data by a machine-learning training system to determine values of configuration parameters for use by a machine-learning processor.
